(19) United States
(12) Patent Application Publication
(10) Pub. No.: US 2023/0158963 A1
(43) Pub. Date: May 25, 2023

(54) ROOF SYSTEM FOR VEHICLE

(71) Applicant: EV FLEET SERVICES LLC, Delaware, OH (US)

(72) Inventor: Zachary Ian Wilson, Delaware, OH (US)

(21) Appl. No.: 18/057,307

(22) Filed: Nov. 21, 2022

Related U.S. Application Data
(60) Provisional application No. 63/264,481, filed on Nov. 23, 2021.
(60) Provisional application No. 63/264,485, filed on Nov. 23, 2021.
(60) Provisional application No. 63/264,486, filed on Nov. 23, 2021.

(51) Int. Cl. B60R 9/048; B60R 9/058; B60J 7/11

(52) U.S. Cl. CPC B60R 9/048; B60R 9/058; B60J 7/11

(57) ABSTRACT

A roof system for a vehicle is provided. The roof system includes a roof panel including a plurality of mounting points. A plurality of components and/or accessories may be mounted to the roof system at the plurality of mounting points. A liner panel may be coupled to the roof panel, defining an interior facing side of the roof system. The liner panel may be coupled to the roof panel by a plurality of fasteners extending through the liner panel and into the roof panel from and interior facing side of the roof system. The liner panel may include a plurality of mounting points providing for the coupling or mounting of a plurality of accessories and/or components to the interior facing side of the roof system.

### CROSS-REFERENCE TO RELATED APPLICATIONS

This application claims priority to U.S. Provisional Application No. 63/264,481, filed on Nov. 23, 2021, entitled “Roof System for Vehicle,” and to U.S. Provisional Application No. 63/264,485, filed on Nov. 23, 2021, entitled “Divider Panel System for Vehicle,” and to U.S. Provisional Application No. 63/264,486, filed on Nov. 23, 2021, entitled “Public Safety Vehicle,” the disclosures of which are incorporated herein by reference in their entireties.

### FIELD

This document relates, generally, to a roof system for a motor vehicle, and in particular to a roof system including mounting points for the mounting of accessories to the roof panel.

### BACKGROUND

A motor vehicle typically includes a body and a roof coupled to the body. The body and the roof may define, for example, an interior cabin, an engine compartment, a cargo compartment and the like.

### SUMMARY

In one general aspect, a roof system for a vehicle includes a roof panel defining an exterior facing side of the roof system; a liner panel defining an interior facing side of the roof system; a first plurality of mounting points defined in the roof panel and configured to provide for mounting of components to the exterior facing side of the roof system; a second plurality of mounting points defined in the liner panel and configured to provide for mounting of components to the interior facing side of the roof system; and a third plurality of mounting points defined in the liner panel and a fourth plurality of mounting points defined in the roof panel, wherein the third plurality of mounting points and the fourth plurality of mounting points are configured to provide for detachable coupling of the liner panel to the roof panel.

In some implementations, the roof panel includes a conductive panel received in a carbon fiber material, wherein the conductive panel defines a ground plane configured to ground at least one component coupled to the roof system via at least one of the first plurality of mounting points or the second plurality of mounting points.

In some implementations, the roof panel is configured to be coupled to a roof frame portion of a vehicle in which the roof system is installed; and the liner panel is configured to be detachably coupled to the roof panel coupled to the vehicle.

In some implementations, a peripheral contour of the roof panel corresponds to a peripheral contour of an opening in the vehicle defined by the roof frame portion of the vehicle.

In some implementations, the roof system includes an opening formed in the roof panel; and a space defined between the roof panel and the liner panel in a coupled configuration of the roof panel and the liner panel, the space being in communication with the opening formed in the roof panel.

In some implementations, the opening is configured to guide one or more cables from one or more components mounted to the roof panel into the space, and the space is configured to guide one or more cables from one or more components mounted to at least one of the roof panel or the liner panel to at least one of a power source or an operation panel.

In some implementations, the first plurality of mounting points are configured to provide for mounting to the roof panel of at least one of a light bar, a siren, a speaker, a camera, an antenna, or a spotlight.

In some implementations, the second plurality of mounting points are configured to provide for mounting, to the liner panel, of at least one of a lighting device, a camera, a control panel, or one or more panels configured to provide for separation of an interior cabin of a vehicle in which the roof system is installed.

In some implementations, the roof panel includes first side surface defining an exterior surface of the roof system; a second side surface facing the liner panel in an installed configuration of the roof system in a vehicle; and a rim arranged in a peripheral portion of the second side surface of the roof panel, extending from the second side surface towards the liner panel in the installed configuration of the roof system.

In some implementations, the roof panel includes a carbon fiber material, the rim is integrally formed with the roof panel.

In some implementations, a peripheral contour of the rim corresponds to a peripheral contour of the roof panel, and wherein the rim is positioned inward from a peripheral edge of the roof panel.

In some implementations, the roof system includes at least one support panel between the roof panel and the liner panel, wherein the at least one support panel is positioned corresponding to at least one of the first plurality of mounting points or at least one of the second plurality of mounting points, wherein the at least one support panel is configured to provide structural support to one or more components mounted to the roof system via the at least one of the first plurality of mounting points or via the at least one of the second plurality of mounting points.

In some implementations, the at least one support panel includes a first support panel positioned between the roof panel and the liner panel, extending across an intermediate portion of the roof system, from a first lateral side portion of the roof panel to a second lateral side portion of the roof panel; and a second support panel positioned between the roof panel and the liner panel, extending from an intermediate portion of the first support panel to a rear side portion of the roof panel.

In some implementations, the at least one support panel includes a third support panel positioned between the roof panel and the liner panel, extending across a front side portion of the roof panel, the first lateral side portion of the roof panel to the second lateral side portion of the roof panel.

In some implementations, the at least one support panel includes a first bent end portion at a first end thereof and configured to be coupled to a corresponding portion of the rim; and a second bent end portion at a second end thereof and configured to be coupled to a corresponding portion of the rim.

In some implementations, the roof system includes a plurality of caps configured to be detachably received in the first plurality of mounting points.

In another general aspect, a method of installing a roof system on a vehicle includes positioning a roof panel on a first side of a roof frame of the vehicle, the roof panel defining a corresponding portion of an exterior surface of the vehicle; positioning a liner panel on a second side of the roof frame of the vehicle, the liner panel defining a corresponding portion of an interior surface of the vehicle; coupling the liner panel and the roof panel to the roof frame, with the roof frame of the vehicle positioned between corresponding peripheral edge portions of the liner panel and the roof panel.

In some implementations, coupling the liner panel and the roof panel to the roof frame includes coupling the roof panel to the roof frame with a first plurality of fasteners extending through a plurality of mounting points defined in the roof panel and into corresponding brackets provided on the roof frame; and coupling the liner panel to the roof panel with a second plurality of fasteners extending through a plurality of mounting points defined in the liner panel and into at least one of corresponding brackets provided on the roof frame, corresponding mounting points provided on the roof panel, or a corresponding support panel coupled to the roof panel. The details of one or more implementations are set forth in the accompanying drawings and the description below. Other features will be apparent from the description and drawings, and from the claims.

### BRIEF DESCRIPTION OF THE DRAWINGS

FIG. 1A is a front perspective view, and FIG. 1B is a rear perspective view, of an example roof portion of an example vehicle.

FIG. 1C is a partial top view of example side supports of an example roof frame of the example vehicle shown in FIGS. 1A and 1B.

FIGS. 1D is a partial side view of the example side supports shown in FIG. 1C.

FIG. 2A is a plan view of a first side of an example roof panel of an example roof system, in accordance with implementations described herein.

FIG. 2B(1) is a plan view, and FIG. 2B(2) is a perspective view, of a second side of the example roof panel of the example roof system shown in FIG. 2A, in accordance with implementations described herein.

FIG. 2C is a cross-sectional view of the example roof panel shown in FIGS. 2A, 2B(1) and 2B(2), taken along line A-A of FIG. 2A.

FIG. 2D is a perspective view of the example roof panel shown in FIGS. 2A-2C.

FIG. 2E is a rear view of the example roof panel shown in FIGS. 2A-2C.

FIG. 2F is a plan view of a second side of an example roof panel of an example roof system, in accordance with implementations described herein.

FIG. 2G is a side view of an example roof panel of an example roof system, in accordance with implementations described herein.

FIG. 2H(1) is a side view, and FIG. 2H(2) is a rear view, example roof panel of an example roof system, in accordance with implementations described herein.

FIG. 2I is a top view example roof panel of an example roof system, in accordance with implementations described herein.

FIG. 3 is a plan view of an example liner panel configured to be coupled to the example roof panel shown in FIGS. 2A-2I.

FIG. 4 is a side view of an example roof system, including an example liner panel coupled to an example roof panel, in accordance with implementations described herein.

FIG. 5A is a front exterior view of the example roof system shown in FIG. 4 installed in an example vehicle, in accordance with implementations described herein.

FIG. 5B is a rear exterior view of the example roof system shown in FIG. 4 installed in an example vehicle, in accordance with implementations described herein

FIGS. 6A-6C are interior views of the example roof panel shown in FIGS. 1A-2I, installed in an example vehicle, in accordance with implementations described herein.

### DETAILED DESCRIPTION

In some situations, it may be desirable to couple or connect accessories to various portions of a body and/or a roof and/or an interior cabin of a vehicle. For example, a motor vehicle to be equipped and/or configured for use as a public safety vehicle may benefit from the ability to attach components such as, for example, lights, antennas, cameras, sensors, consoles, partitions, interfaces and other such components and/or accessories to various portions of the motor vehicle. Such a motor vehicle may further benefit from the ability to remove and/or replace such components and/or accessories, to rearrange the installation position of various components and/or accessories, and the like. The incorporation, or mounting, or attachment of these types of components into and/or onto the vehicle in an efficient, secure manner may enhance the functionality and utility of the vehicle.

A roof system, in accordance with implementations described herein, may be coupled to a motor vehicle, for example, to a frame portion of a motor vehicle, to provide for the mounting of components and/or accessories into and/or onto the vehicle. The mounting of components and/or accessories into and/or onto the vehicle via the roof system may allow the vehicle to be configured for a particular application such as, for example, a public safety application. In some implementations, the roof system may include a roof panel that defines an exterior contour of the roof portion of the vehicle. In some implementations, the roof panel may include one or more mounting points, or attachment points, providing for the attachment of components to the roof panel. In some implementations, the roof panel may be made of a material that provides a measure of structural integrity, to support the mounting of components thereto, to augment the structural integrity of the roof portion of the motor vehicle, and the like. In some examples, the roof panel may include a carbon fiber material, or other such material. In some implementations, the roof panel may include a conductive portion, for example, a conductive panel or a conductive plate, defining a ground plane for electronic components coupled to the roof panel. In some implementations, a liner panel may be attached to an interior facing, or cabin facing side of the roof panel. A space formed between the roof panel and the liner panel may guide wires, cables and the like from components attached to the roof system to control panels, power sources and the like in the vehicle. In some implementations, components such as, for example, lights, control panels and the like, may be mounted to the liner panel and/or in the space formed between the liner panel and the roof panel, for operation from within the cabin. In some implementations, the liner panel may be detachable from the roof panel, for example, from within the cabin. The ability to attach/detach the liner panel from the roof panel may provide access to component mounting points and the like.

In some examples, a roof system in accordance with implementations described herein may be installed in an existing vehicle and/or retrofit into an existing vehicle, to configure the vehicle for a particular application. For example, in some vehicles, the existing roof may not support the coupling and/or mounting of components and/or accessories thereto. For example, some vehicles include a panoramic roof in which a relatively large portion, or essentially an entirety, of the roof is glass, thus allowing additional daylight to enter the passenger cabin and expanding a view of the outdoors. However, this type of glass roof does not provide the structural support needed for the mounting of components and/or accessories thereto. Thus, a roof system in accordance with implementations described herein, may be retrofit into an existing vehicle to provide for the mounting of components and/or accessories, both to an exterior facing side of the roof system and to an interior cabin facing side of the roof system, allowing the vehicle to be configured for various applications.

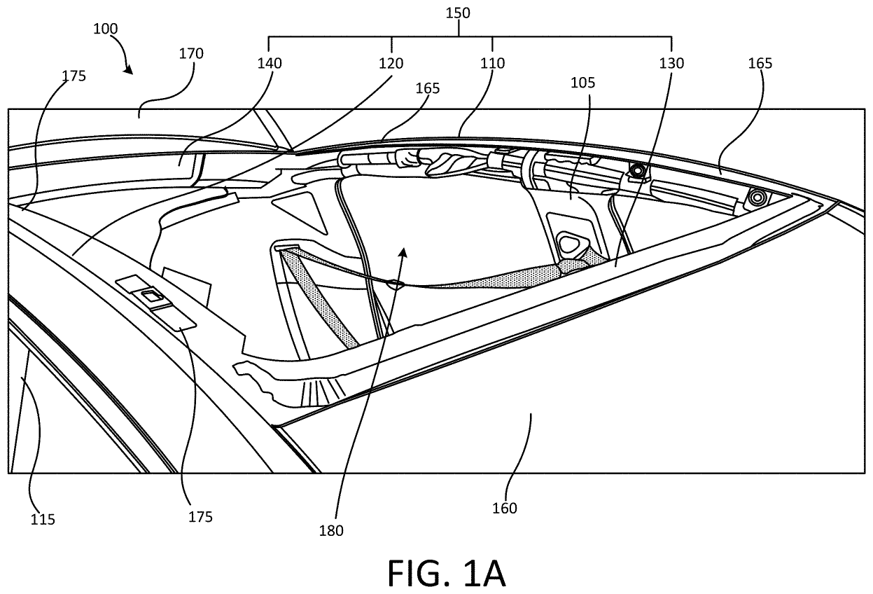

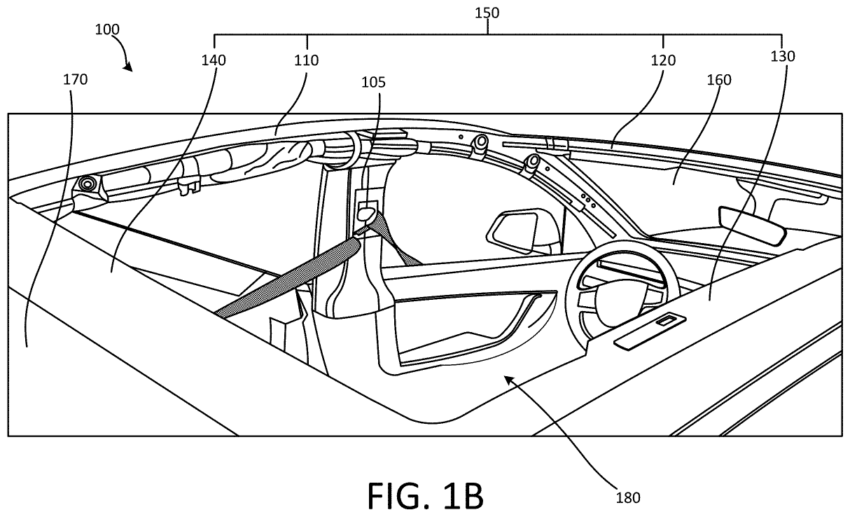

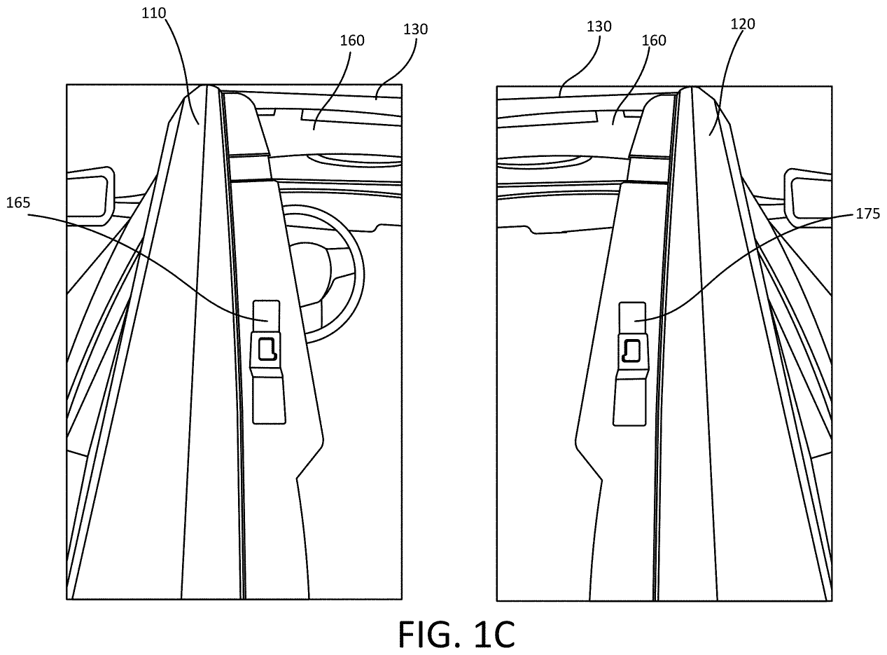

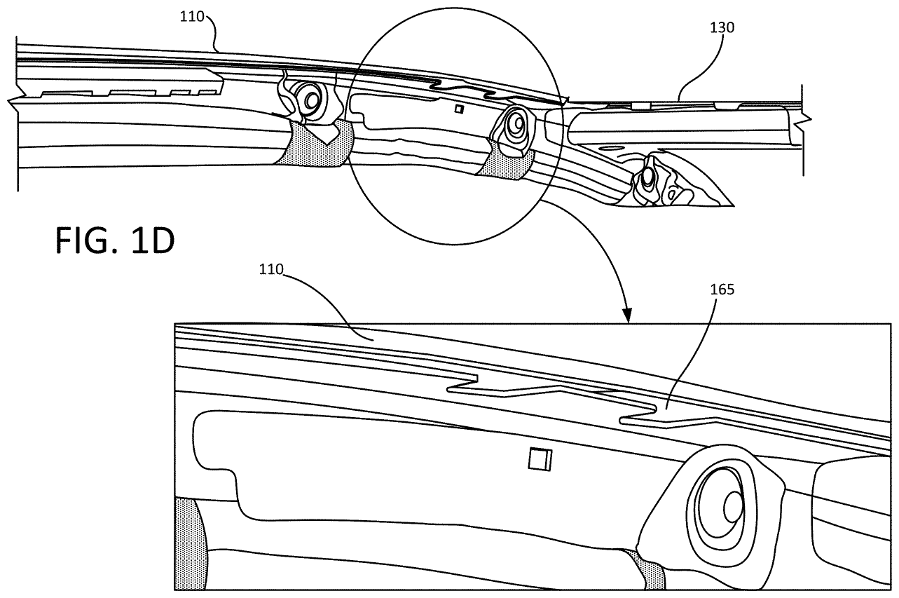

FIG. 1A is a front perspective view, and FIG. 1B is a rear perspective view, of a roof portion of an example vehicle, prior to installation of a roof system, in accordance with implementations described herein. In the example shown in FIGS. 1A and 1B, an existing roof has been removed, in preparation for the installation of a roof system, in accordance with implementations described herein. In the example shown in FIGS. 1A and 1B, a configuration of the existing roof may have been unable to support the mounting of components and/or accessories thereto, as described above. For example, the existing roof may have been at least partially glass, and thus unable to support the mounting of components and/or accessories thereto.

As shown in FIGS. 1A and 1B, an opening 180 is defined in the roof portion of the vehicle 100. The opening 180 is defined by a first side support 110 on a first (i.e., driver) side of the opening 180, a second side support 120 on a second (i.e., passenger) side of the opening 180, a third side support on a third (i.e., front) side of the opening 180 proximate a front windshield 160 of the vehicle 100, and a fourth side support 140 on a fourth (i.e., rear) side of the opening 180 proximate a rear window 170 enclosing a cargo compartment of the vehicle 100. The first side support 110, the second side support 120, third side support 130, and the fourth side support 140 may define a roof frame 150. A first support pillar 105 at the first side of the opening 180 and a second support pillar 115 at the second side of the opening 180 may provide support to the roof frame 150. In some examples, one or more brackets 165 may be positioned on the first side support 110, and one or more brackets 175 may be positioned on the second side support 120. The one or more brackets 165, 175 may provide for attachment of a roof panel/roof system to the roof frame 150 (see also FIG. 1C). More, or fewer brackets 165, 175, arranged differently than shown in FIGS. 1A-1C, may be provided on the roof frame 150. In some implementations, the one or more brackets 165, 175 may be existing brackets used to couple the previously installed roof to the vehicle 100. In some implementations, the one or more brackets 165, 175 may be installed after the removal of the previous roof. In some implementations, the one or more brackets 165, 175 may include a combination of previously installed brackets and new/additional brackets installed after removal of the previous roof. As illustrated in the partial side view of the first side support 110 shown in FIG. 1D, the first side support 110 (and the second side support 120 and/or third side support 130 and/or fourth side support 140, though not shown) may include additional structure to provide support for the roof panel/roof system to be attached thereto.

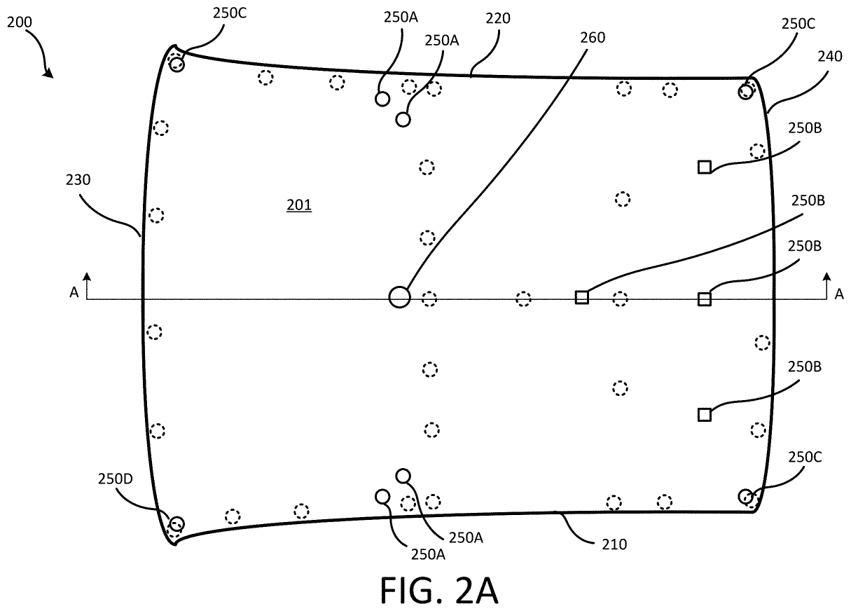

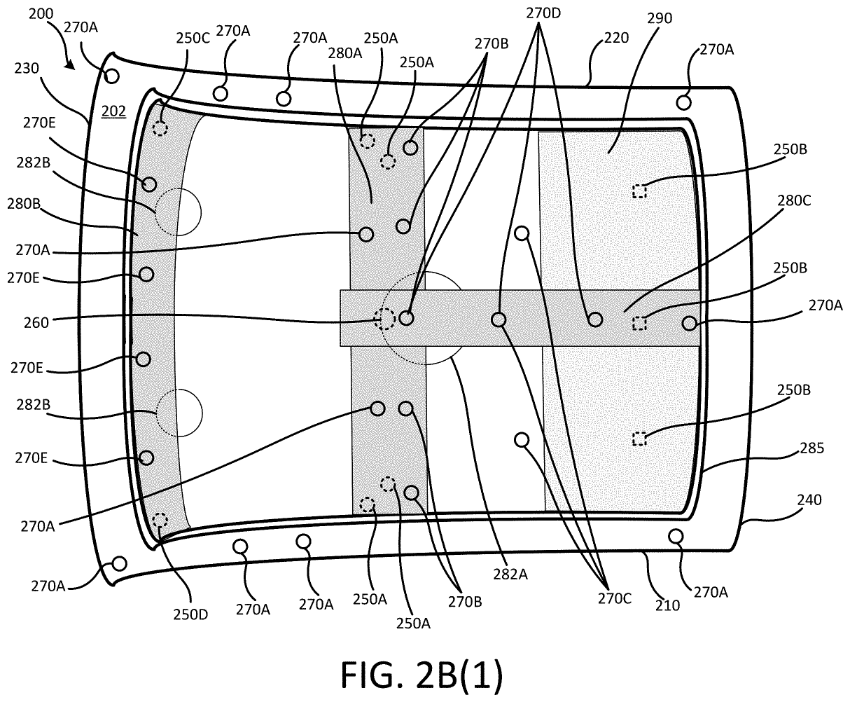

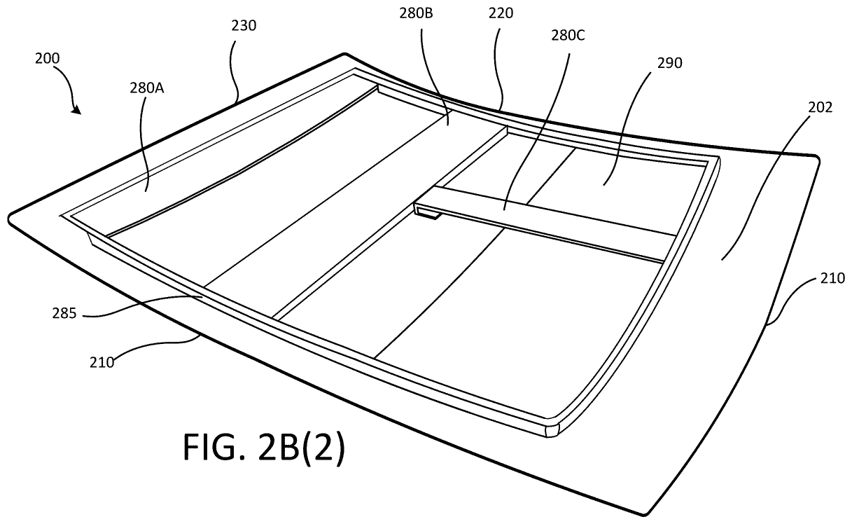

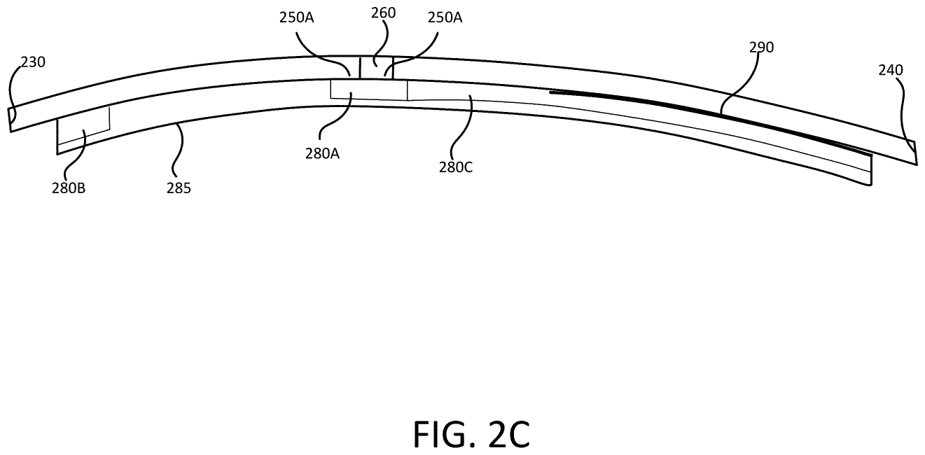

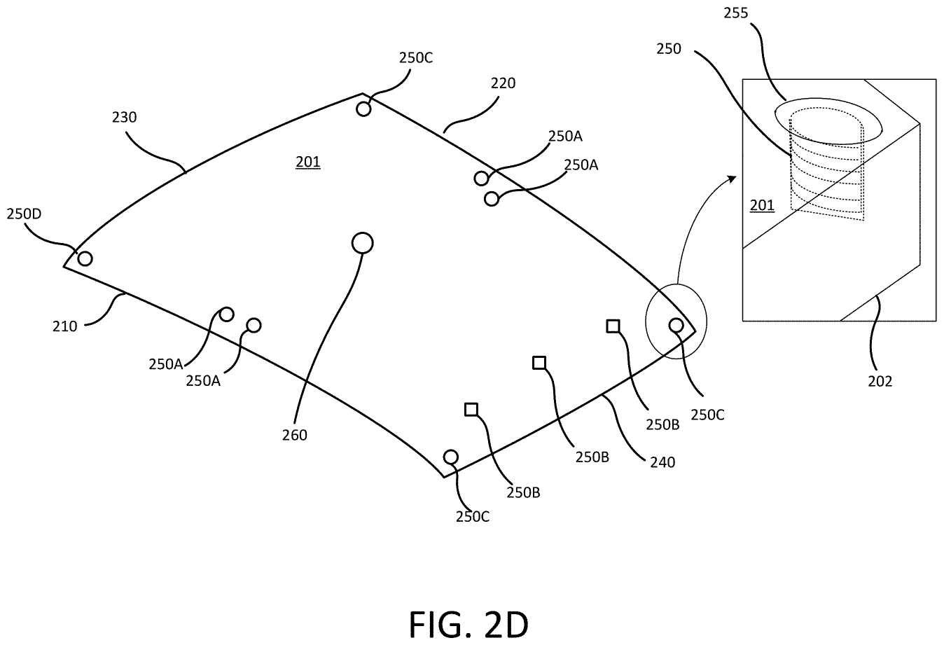

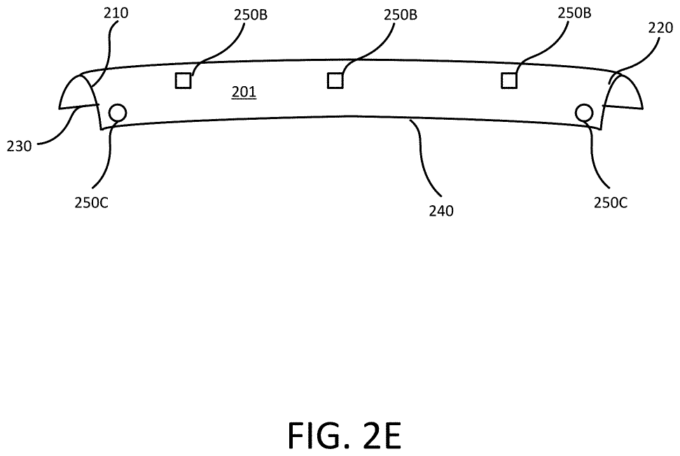

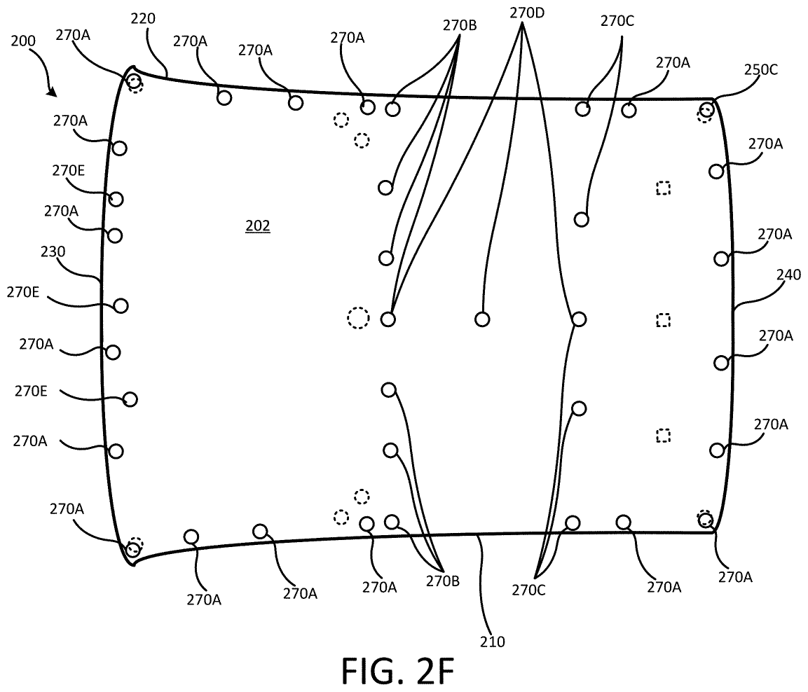

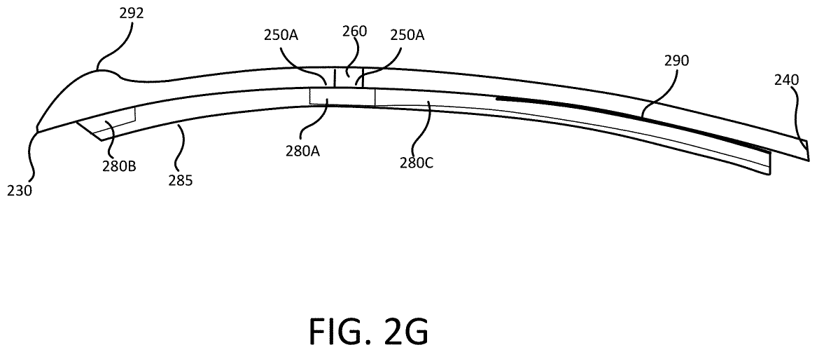

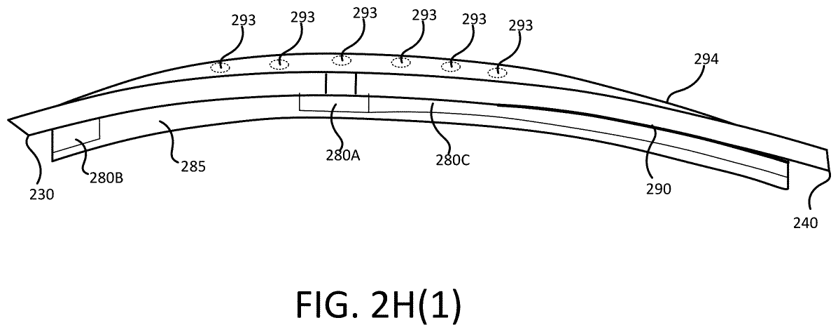

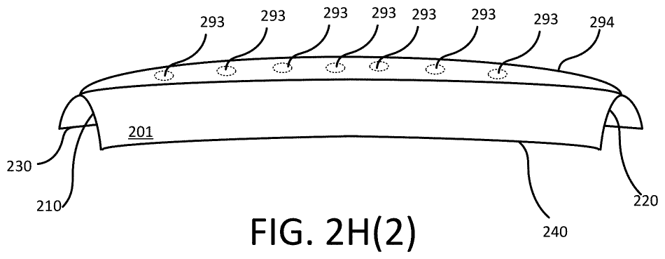

FIGS. 2A-2E illustrate an example roof panel 200 of a roof system for a motor vehicle, in accordance with implementations described herein. In particular, FIG. 2A is a top view of a first (exterior facing) side surface 201 of the example roof panel 200, in accordance with implementations described herein. The first side surface 201 of the example roof panel 200 may be a side that faces outward, or defines an exterior of the roof system when the roof system is installed on a vehicle such as the example vehicle shown in FIGS. 1A and 1B. FIG. 2B(1) is a plan view, and FIG. 2B(2) is a perspective view, of a second (interior facing) side surface 202 of the example roof panel 200. The second side surface 202 of the roof panel 200 may face inward, toward an interior of the example vehicle 100. FIG. 2C is a cross-sectional view taken along line A-A of FIG. 2A. FIG. 2D is a perspective view, and FIG. 2E is a rear view of the example roof panel 200.

The example roof panel 200 shown in FIGS. 2A-2E is defined by a first side portion 210 corresponding to the first side support 110 of the roof frame 150, a second side portion 220 corresponding to the second side support 120 of the roof frame 150, a third side portion 230 corresponding to the third side support 130 of the roof frame 150, and a fourth side portion 240 corresponding to the fourth side support 140 of the roof frame 150. A contour, for example a peripheral contour, of the roof panel 200 may correspond to a contour, for example a peripheral contour, defined by the roof frame 150 of the example vehicle 100. Mating surfaces of the roof panel 200 and the roof frame 150 may be substantially flush when the roof panel 200 is positioned in the roof frame 150.

In some implementations, the roof panel 200 may include a plurality of mounting points 250, or attachment points 250, defined in the first (i.e., exterior) side surface 201 of the roof panel 200. The mounting points 250 may facilitate the attachment, or mounting, of components, accessories and the like. In a situation in which the vehicle 100 is to be configured for a public safety application, mounting points 250 defined in and/or on the first side surface 201 of the example roof panel 200 may facilitate the mounting of components such as, for example, lighting devices, antennas, cameras, sirens, speakers, and other such components at the first (exterior facing) side surface 201 thereof In the example arrangement shown in FIG. 2A, first mounting points 250A are located proximate the first side portion 210 and the second side portion 220 of the roof panel 200. The first mounting points 250A may be positioned on the roof panel 200 so as to facilitate the mounting of a light bar to the roof panel 200, that extends across the roof panel 200, from the first side portion 210 to the second side portion 220 thereof. One or more second mounting points 250B may be positioned on the roof panel 200 to facilitate the mounting of equipment such as, for example, antennas and the like. One or more third mounting points 250C may be positioned on the roof panel 200 to facilitate the mounting of equipment such as, for example, sensors including, for example light sensors, or image sensors, or cameras, and the like. One or more fourth mounting points 250D may be positioned on the roof panel 200 to facilitate the mounting of equipment such as, for example, auxiliary lighting devices including, for example spotlights, search lights and the like, sirens and/or speakers and the like. In some implementations, one or more openings 260 may be formed in the roof panel 200. The one or more openings 260 may guide cables, cords, wires and the like associated with equipment mounted to the roof panel 200 for connection to a control panel providing for control of the mounted equipment.

In some implementations, a conductive panel 290 may be incorporated into the roof panel 200, as shown in FIGS. 2B(1), 2B(2) and 2C. In some examples, the conductive panel 290 may be grounded to a vehicle in which the roof panel 200 is installed, to define a ground plane for electronic components that are coupled to and/or mounted on the roof panel 200. In some examples, the conductive panel 290 is positioned adjacent to, or near, the second side surface 202 of the roof panel 200. In some examples, the conductive panel 290 extends from an area proximate the fourth side portion 240 of the roof panel 200 to an intermediate portion of the roof panel 200, to provide for grounding of components mounted at the second mounting points 250B and/or the first mounting points 250A.

The number and/or arrangement and/or combination(s) of mounting points 250A, 250B, 250C, 250D, openings 260 and the like defined in the first side surface 201 of the example roof panel 200 shown in FIG. 2A is just one example of the mounting points 250 that may be incorporated into the roof panel 200, and accessible from the first (i.e., exterior) side surface 201 of the roof panel 200, simply for purposes of discussion and illustration. The roof panel 200 may include more, or fewer, mounting points 250 and/or openings 260, different arrangements of mounting points 250 and/or openings 260, and/or different combinations of types of mounting points 250 and/or openings 260, than shown in FIG. 2A and described above.

In some situations, configuration of the vehicle 100 for a particular application may make use of some, but not all of the mounting points 250 available in and/or on the roof panel 200. In some implementations, caps 255 (see FIG. 2D) may be removably received in the mounting points 250 when not in use for the mounting of components to the roof panel 200. Positioning of the cap 255 in the mounting point 250 when not in use may inhibit infiltration of debris, moisture and the like into the mounting point 250, may preserve the mounting point 250 for later use, and the like. In some examples, the caps 255 may be threadbly inserted into and removed from the mounting points 250. In some examples, the caps 255 may be press fit or interference fit or transition fit into the mounting points 250. Other methods of inserting the caps 255 into the mounting points 250 and/or retaining the caps 255 in the mounting points 250, and removing the caps 255 from the mounting points 250 may also be used.

As shown in FIGS. 2B(1) and 2B(2), in some examples, a rim 285 may be formed on the second side surface 202 of the roof panel 200, extending from the second side surface 202 toward the interior cabin of the vehicle 100. In some examples, a contour of the rim 285 may correspond to a contour of the roof frame 150 and/or a contour of the roof panel 200, to facilitate the coupling of the roof panel 200 to the vehicle 100. In the example shown in FIGS. 2B(1) and 2B(2), a first support panel 280A extends across an intermediate portion of the roof panel 200, between opposite side portions of the rim 285 corresponding to the first and second side portions 210, 220 of the roof panel 200. In the example shown in FIGS. 2B(1) and 2B(2), a second support panel 280B extends across a front portion of the roof panel 200 proximate the third side portion 230 of the roof panel 200, between opposite side portions of the rim 285 corresponding to the first and second side portions 210, 220 of the roof panel 200. In the example shown in FIGS. 2B(1) and 2B(2), a third support panel 280C extends from an intermediate portion of the first support panel 280A to a rear portion of the rim 285 proximate the fourth side portion 240 of the roof panel 200. In some examples, the first support panel 280A, the second support panel 280B, and the third support panel 280C may each include bent end portions, to facilitate the coupling of the end portions of the support panels 280A, 280B, 280C to corresponding portions of the rim 285. In some examples, a first protrusion 282A is formed at an intermediate portion of the second side surface 202 of the roof panel 200. In the example shown in FIG. 2B(1), the first protrusion 282A is formed at a position of the roof panel 200 corresponding to the first support panel 280A and the third support panel 280C, to provide structural support to the corresponding portions of the first and third support panels 280A, 280C. In some examples, at least one second protrusion 282B is formed at a portion of the second side surface 202 of the roof panel 200 corresponding to the second support panel 280B to provide structural support to the second support panel 280B. In the example shown in FIG. 2B(1), two second protrusions 282B are provided at intermediate locations between the opposite end portions of the second support panel 280B.

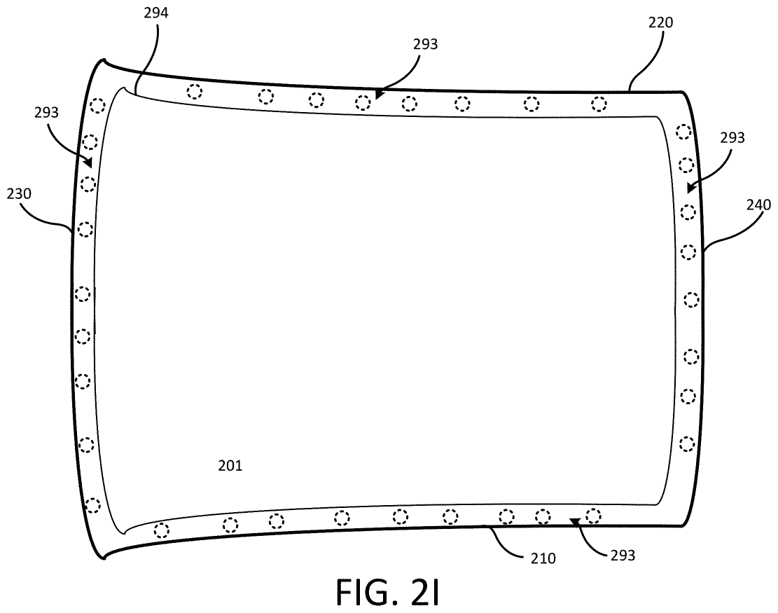

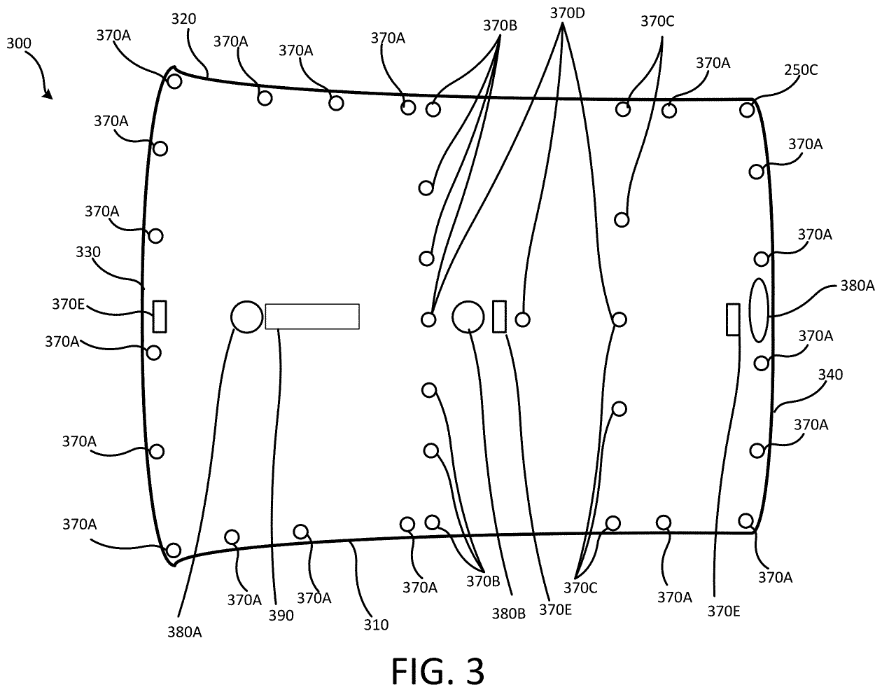

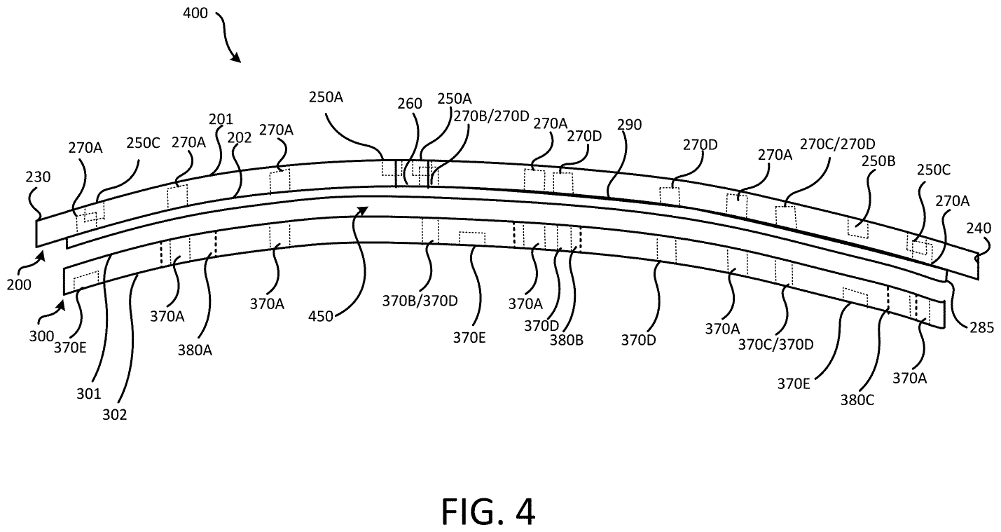

As shown in FIG. 2B(1), a plurality of mounting points 270 may provide for the coupling, removal and replacement of various components including a liner panel 300 (to be described in more detail below with respect to FIGS. 3 and 4) to the roof panel 200. The mounting points 270 may provide structural support for the mounting of barriers and/or dividers within the interior cabin of the vehicle 100. The mounting points 270 may provide for the mounting of components and/or accessories in the interior cabin of the vehicle 100. For example, as shown in FIG. 2B(1), a plurality of first mounting points 270A may provide for the removable/replaceable coupling of the liner panel 300 to the roof panel 200. A plurality of second mounting points 270B may provide structural support for the installation of a first barrier panel (not shown) that is positioned in the interior cabin of the example vehicle 100. The first barrier panel would extend essentially from the first side portion 210 to the second side portion 220 of the roof panel 200, down to a floor of the interior cabin, and from the first support pillar 105 to the second support pillar 115 to define a barrier between a front seating area of the interior cabin and a rear seating area of the interior cabin of the example vehicle 100. A plurality of third mounting points 270C may provide structural support for the installation of a second barrier panel (not shown) that extends essentially from the first side portion 210 to the second side portion 220 of the roof panel 200 to define a barrier between the rear seating area of the cabin and a cargo compartment of the example vehicle 100. A plurality of fourth mounting points 270D may provide structural support for the installation of a divider panel (not shown) that extends between the first barrier panel and the second barrier panel, to divide the rear seating area into two separate rear seating area sections. A plurality of fifth mounting points 270E may provide structural support for the installation of various components at the front portion of the interior cabin of the vehicle 100, proximate a top portion of the windshield 160 such as, for example, interior lights, interior cameras, control panels, and the like. In some examples, the vehicle 100 equipped for a public safety application may include a visor light bar coupled in the vehicle 100 at the fifth mounting points 270E instead of, or in addition to, a rooftop mounted lightbar.

FIG. 2F illustrates an implementation of the roof panel 200 in which the mounting points 270 (270A, 270B, 270C, 270D, 270E) are formed in the second side surface 202 of the roof panel 200. In the example shown in FIG. 2F, the material of the roof panel 200 may be fabricated such that the mounting points 270 may be formed in the second side surface 202 of the roof panel 200, without the first support panel 280A and/or the second support panel 280B and/or the third support panel 280C shown in FIGS. 2B(1) and 2B(2).

When configuring the vehicle for a public safety application, installation of the first barrier panel and the second barrier panel (not shown) may provide for containment of rear seat passenger(s) within the rear seating area. Similarly, the divider panel may provide for isolation between rear seat passengers and/or isolation of passenger(s) and equipment within the rear seating area. Securing and/or mounting of the first barrier panel and/or the second barrier panel and/or the divider panel into the mounting points 270B, 270C, 270D of the roof panel 200 (via corresponding mounting points 370B, 370C, 370D formed in the liner panel 300 shown in FIG. 3) of the roof system 400 may allow for mounting without the removal/replacement of other structural portions of the interior cabin of the vehicle 100. Further, securing and/or mounting of the barrier panels and/or divider panels into the mounting points 270B, 270C, 270D of the roof panel 200 in this manner may allow for modular configuration/re-configuration of the interior cabin of the example vehicle 100, so that the interior cabin may be relatively quickly and easily reconfigured for a particular passenger and/or equipment transport need. In contrast, known systems do not provide for securing these types of barrier panels and/or divider panels into the roof of the vehicle. Rather, known systems typically require at least partial disassembly of the support pillars 105, 115 for securing of these types of dividers. Additionally, known systems typically rely on significant additional structure along the peripheral portions of the barrier panels and/or divider panels to provide for structural support of the barrier panels and/or divider panels in portions thereof not otherwise supported by, for example, the roof system in the manner described. Further, known systems, once configured with these types of barrier panels and/or divider panels, cannot be quickly or easily reconfigured without considerable disassembly of the interior cabin.

The number and/or arrangement and/or combination(s) of mounting points 270 defined in the second side surface 202 of the example roof panel 200 shown in FIGS. 2B(1) and 2B(2) and/or FIG. 2F is just one example of the mounting points 270 that may be incorporated into the roof panel 200, and accessible from the second side surface 202 of the roof panel 200, simply for purposes of discussion and illustration. The second side surface 202 of the roof panel 200 may include more, or fewer, mounting points 270, different arrangements of mounting points 270, and/or different combinations of types of mounting points 270, than shown in FIGS. 2B(1) and 2B(2) and described above.

A contour of the example roof panel 200 described above is substantially smooth, following a general profile of the vehicle 100 in which the roof panel 200 is to be installed. As shown in FIG. 2G, in some examples, a vortex generator 292 including a hump or a ridge may be incorporated into a front portion of the first side surface 201 of the roof panel 200, that extends into the airflow surrounding the vehicle 100 during operation. This may cause a disruption in the airflow across the first side surface 201 of the roof panel 200, to redirect air over equipment and/or components and/or accessories mounted on the roof panel 200. Redirection around the equipment and/or components and/or accessories in this manner may reduce drag and/or reduce noise levels in the interior cabin of the vehicle 100, and may provide some shielding that preserves the integrity of the equipment and/or components and/or accessories and the mounting thereof to the roof panel 200.

In some examples, the roof panel 200 may include a transparent lens portion 294 incorporated into the first side surface 201 of the roof panel 200, as shown in the side view illustrated in FIG. 2H(1) and the rear view illustrated in FIG. 2H(2). The lens portion 294 may be configured to receive equipment such as, for example, high output lighting equipment 293, i.e., high output LED lighting, to provide emergency waring lighting, scene lighting, and the like. In some examples, incorporation of the transparent lens portion 294 and lighting equipment 293 installed therein may preclude the need for separate installation of other lighting accessories such as the rooftop mounted lightbar, spotlights, and other lighting equipment. Rather, the lighting equipment 293 received in the transparent lens portion 294 may provide the lighting previously provided by this type of equipment. Incorporation of the transparent lens portion 294 does not preclude the mounting and/or incorporation of other types of equipment and/or components and/or accessories into and/or onto the roof panel 200. FIG. 2H(1) illustrates the example transparent lens portion 294 oriented so as to extend substantially in parallel to the first side portion 210 and the second side portion 220 of the roof panel 200. FIG. 2H(2) illustrates the example transparent lens portion 294 oriented so as to extend substantially in parallel to the third side portion 230 and the fourth side portion 240. Other configurations, positioning, combinations of equipment and the like may be incorporated into the roof panel 200 to accommodate lighting for a particular use application and/or environment.

In some examples, the roof panel 200 may include the transparent lens portion 294 incorporated into the first side surface 201 of the roof panel 200, as shown in FIG. 2I. In the example shown in FIG. 2I, the transparent lens portion 294 extends along substantially an entire peripheral portion of the roof panel 200. In some examples, the transparent lens portion 294 may be positioned along portions of the peripheral portion of the roof panel 200. As with the example shown in FIG. 2H(1) and 2H(2), incorporation of the transparent lens portion 294 and lighting equipment 293 installed therein may preclude the need for separate installation of other lighting accessories such as the rooftop mounted lightbar, spotlights, and other lighting equipment. Rather, the lighting equipment 293 received in the transparent lens portion 294 may provide the lighting previously provided by this type of equipment. Incorporation of the transparent lens portion 294 as shown in FIG. 2I does not preclude the mounting and/or incorporation of other types of equipment and/or components and/or accessories into and/or onto the roof panel 200. FIG. 2G illustrates one example implementation of incorporation of the lighting equipment 293 received in the example transparent lens portion 294 of the roof panel 200. Other configurations, positioning, combinations of equipment and the like may be incorporated into the roof panel 200 to accommodate lighting for a particular use application and/or environment.

In some examples, the roof panel 200 may be made of a carbon fiber material. In some examples, the roof panel 200 may be made of a metal material. In some examples, the roof panel may be made of other types of materials. In some examples, the roof panel 200 may be made of a combination of materials. Materials and/or combinations of materials of the roof panel 200 may be adjusted based on, for example, a particular installation configuration, a use environment of the vehicle on which the roof panel 200 is to be installed, equipment and/or components and/or accessories to mounted in and/or on the roof panel 200, and other such factors.

FIG. 3 illustrates an example liner panel 300 that can be removably coupled to the example roof panel 200 shown in FIGS. 2A-2I. A first side surface 301 of the example liner panel 300 may be coupled so as to be oriented toward the interior cabin of the example vehicle 100 when the roof system is installed in the opening 180/coupled to the roof frame 150 of the example vehicle 100 (see FIG. 4). A second side surface 302 of the example liner panel 300 may define a mating surface with the second side surface 202 of the roof panel 200 (see FIG. 4). The example liner panel 300 may be defined by a first side portion 310 corresponding to the first side portion 210 of the roof panel 200 and the first side support 110 of the roof frame 150; a second side portion 320 corresponding to the second side portion 220 of the roof panel 200 and the second side support 120 of the roof frame 150; a third side portion 330 corresponding to the third side portion 230 of the roof panel 200 and the third side support 130 of the roof frame 150; and a fourth side portion 330 corresponding to the fourth side portion 240 of the roof panel 200 and the fourth side support 140 of the roof frame 150. A contour of the liner panel 300 may correspond to a contour defined by the roof panel 200 and/or a contour of the roof frame 150 of the example vehicle 100, such that mating surfaces of the liner panel 300, the roof panel 200 and the roof frame 150 are substantially flush when in the installed configuration.

In some implementations, the liner panel 300 may include a plurality of mounting points 370, or attachment points 370. At least some of the plurality of mounting points 370 may facilitate the attachment, or mounting, or coupling of the liner panel 300 to the roof panel 200, and/or may facilitate the mounting of components, accessories and the like. In the example arrangement shown in FIG. 3, the liner panel 300 includes a plurality of first mounting points 370A, at positions corresponding to the plurality of first mounting points 270A formed in the second side surface 202 of the roof panel 200. Alignment of the first mounting points 370A of the liner panel 300 with the first mounting points 270A of the roof panel 200 may provide for the insertion of fasteners through the liner panel 300 and into the roof panel 200, for the removable/replaceable coupling of the liner panel 300 to the roof panel 200.

Similarly, a plurality of second mounting points 370B may be formed in the liner panel 300, at positions corresponding to the second mounting points 270B formed in the second side surface 202 of the roof panel 200. Alignment of the second mounting points 370B of the liner panel 300 with the second mounting points 270B of the roof panel 200 may allow for connection portions of the first barrier panel (described above, not shown) to be inserted through the liner panel 300 and into the roof panel 200, to provide structural support for the installation of the first barrier panel. In some examples, positioning of the second mounting points 370B of the liner panel 300 and the second mounting points 270B of the roof panel 200 may correspond to a position and/or contour of a rear portion of the front seat/front seating area and a corresponding contour of the first barrier panel.

A plurality of third mounting points 370C may be formed in the liner panel 300, at positions corresponding to the third mounting points 270C formed in the second side surface 202 of the roof panel 200. Alignment of the third mounting points 370C of the liner panel 300 with the third mounting points 270C of the roof panel 200 may allow for connection portions of the second barrier panel (described above, not shown) to be inserted through the liner panel 300 and into the roof panel 200, to provide structural support for the installation of the second barrier panel. In some examples, positioning of the third mounting points 370C of the liner panel 300 and the third mounting points 270C of the roof panel 200 may correspond to a position and/or contour of a rear portion of the rear seat/rear seating area and a corresponding contour of the second barrier panel.

A plurality of fourth mounting points 370D may be formed in the liner panel 300, at positions corresponding to the fourth mounting points 270D formed in the second side surface 202 of the roof panel 200. Alignment of the fourth mounting points 370D of the liner panel 300 with the fourth mounting points 270D of the roof panel 200 may allow for connection portions of the divider panel (described above, not shown) to be inserted through the liner panel 300 and into the roof panel 200, to provide structural support for the installation of the divider panel. In some examples, positioning of the fourth mounting points 370D of the liner panel 300 and the fourth mounting points 270D of the roof panel 200 may extend between the rear portion of the front seat/front seating area the rear portion of the rear seat/rear seating area, between the mounting of the first barrier panel and the mounting of the second barrier panel. In some implementations, one or more fifth mounting points 370E may be formed in the liner panel 300. The fifth mounting points 370E may provide for the mounting of accessories to the interior of the roof system in the interior cabin of the vehicle, including, for example, cameras and the like facing into the interior cabin.

In some implementations, one or more lighting devices 380 may be coupled to, or installed in the liner panel 300. The example arrangement shown in FIG. 3 includes a first lighting device 380A that may be operated to selectively illuminate the front seating area of the interior cabin of the example vehicle 100, a second lighting device 380B that may be operated to selectively illuminate the rear seating area of the interior cabin of the example vehicle 100, and a third lighting device 380C that may be operated to selectively illuminate the cargo compartment of the example vehicle 100. In some implementations, one or more of the lighting devices 380 installed in the liner panel 300 may be operable in different modes. For example, one or more of the lighting devices 380 may be configured to output light in multiple different colors. For example, in a first mode one or more of the lighting devices 380 may be configured to output white light for maximum illumination of a particular portion of the interior cabin of the vehicle. In a second mode, one or more of the lighting devices 380 may be configured to output red light, to preserve night vision. In a third mode, one or more of the lighting devices 380 may be configured to operate in a disinfecting mode, in which light having disinfecting properties is output by the lighting device 380 to provide for disinfection of a corresponding portion of the interior cabin of the vehicle 100. For example, in some implementations, one or more of the lighting devices 380 may operate at antimicrobial light wavelengths that output both illumination and antimicrobial properties. In some situations, operation at antimicrobial light wavelengths may initiate a photoreaction with porphyrin molecules inherent in microorganisms. As the porphyrin molecules are photo-reactive, the antimicrobial light wavelengths emitted by the one or more lighting devices 380 may excite the porphyrin molecules, causing irreparable damage to the cellular membrane from the inside out.

In some implementations, one or more control panels 390 may be coupled to, or installed in the liner panel 300. The example arrangement shown in FIG. 3 includes a control panel 390 installed in a portion of the liner panel 300 that is accessible from the front seating area of the interior cabin of the example vehicle 100. The control panel 390 may provide for operation and control of various components and/or accessories coupled to and/or installed in the liner panel 300 and/or the roof panel 200 of the roof system. For example, the control panel 390 may provide for driver operation and control of the first lighting device 380A, the second lighting device 380B, the third lighting device 380C, cameras mounted in the interior cabin of the example vehicle, and other such components and/or accessories mounted on and/or coupled to the roof system 400.

The number and/or arrangement and/or combination(s) of mounting points 370 and/or devices 380 and/or control panels 390 defined in the liner panel 300 shown in FIG. 3 is just one example of the mounting points 370 and/or devices 380 and/or control panels 390 that may be incorporated into the liner panel 300, and accessible from a side of the liner panel 300 that is accessible from the interior cabin of the vehicle 100, simply for purposes of discussion and illustration. The liner panel 300 may accommodate more, or fewer, mounting points 370 and/or devices 380 and/or control panels 390, different arrangements of mounting points 370 and/or devices 380 and/or control panels 390, and/or different combinations of types of mounting points 370 and/or devices 380 and/or control panels 390, than shown in FIG. 3 and described above.

FIG. 4 is a side view of an example roof system 400, in accordance with implementations described herein. The example roof system 400 may be installed in a vehicle, such as, for example, the example vehicle 100 shown in FIGS. 1A-1D. For example, the roof system 400 may be received in the opening 180 and coupled to the roof frame 150 of the example vehicle 100 shown in FIGS. 1A-1D. The example roof system 400 may provide for the attachment, or coupling, or mounting of components and/or accessories thereto as described above, to in turn allow the vehicle to be configured for a particular application or use environment.

As shown in FIG. 4, the example roof system 400 may include the example liner panel 300 (described above with respect to FIG. 3) coupled to the example roof panel 200 (described above with respect to FIGS. 2A-2I). In some examples, the roof panel 200 may be coupled to the roof frame 150 of the vehicle 100 by, for example, fasteners that couple the roof panel 200 to the roof frame 150 at one or more of the mounting points 250 formed in the first side surface 201 of the roof panel 200 and/or one or more of the mounting points 270 formed in the second side surface 202 of the roof panel 200. The liner panel 300 may be coupled to the roof panel 200 (secured to the roof frame 150 of the vehicle 100 in this manner) by fasteners extending through one or more of the mounting points 370A defined in the liner panel 300, and into the corresponding mounting points 270A formed in the second side surface 202 of the roof panel 200, to couple the liner panel 300 to the roof panel 200. In some examples, the corresponding side support 110, 120, 130, 140 of the roof frame 150 of the vehicle may be positioned between the corresponding side portion 210, 220, 230, 240 of the roof panel 200 and the corresponding side portion 310, 320, 330, 340 of the liner panel 300.

In some examples, fasteners may extend through the mounting points 370A in the liner panel 300, through corresponding openings in the side supports 110, 120, 130, 140 of the roof frame 150 of the vehicle 100, and into the corresponding mounting points 270A in the second side surface 202 of the roof panel 200, to couple the liner panel 300 and the roof panel 200 to the vehicle 100.

The liner panel 300 may be detached from the roof panel 200 by removal of the fasteners, for example from the interior cabin of the vehicle 100. In some examples, the roof panel 200 may remain fixed to the roof frame 150 of the vehicle 100 while the liner panel 300 is detached from the roof panel 200. This may provide easy access to components, accessories and the like mounted to and/or in and/or on the roof panel 200 and/or the liner panel 300 for removal and/or servicing and/or replacement of the components and the like. The ability to remove and replace the liner panel 300 from the roof panel 300 can be accomplished without removal or disassembly of other components of the interior cabin of the vehicle such as, for example, the support pillars 105, 115 and associated structural components, allowing for a less intrusive removal and replacement of the liner panel 300, faster and more efficient servicing of components, and the like.

In some examples, a space 450 may be defined between the liner panel 300 and the roof panel 200. Cords, wires, cables from components, accessories and the like mounted to the roof panel 200 and/or to the liner panel 300 may be routed through the space 450, so that the cords, wires, cables, and the like may be guided and/or attached to respective power sources, control panels (i.e., control panels 390 in the roof system 400 and/or other control panels in the example vehicle 100) and the like. The space 450 may be in communication with the one or more openings 260 and/or one or more of the mounting points 250 formed in the roof panel 200 to facilitate the routing of cords, cables, wires and the like into and through the space 450.

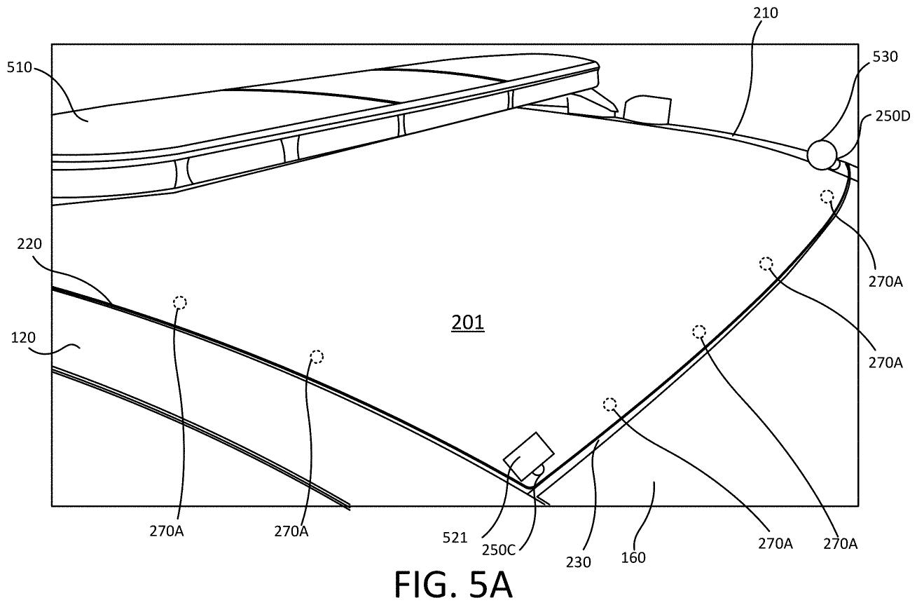

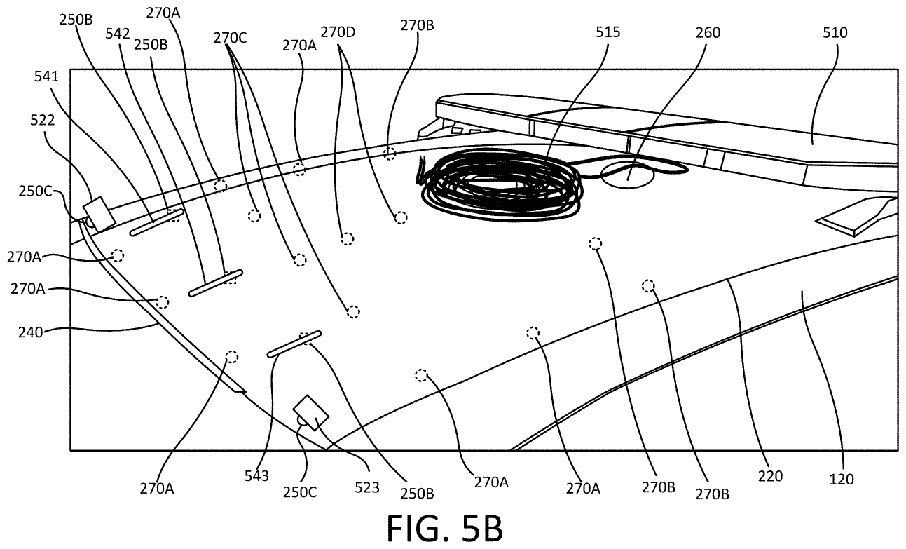

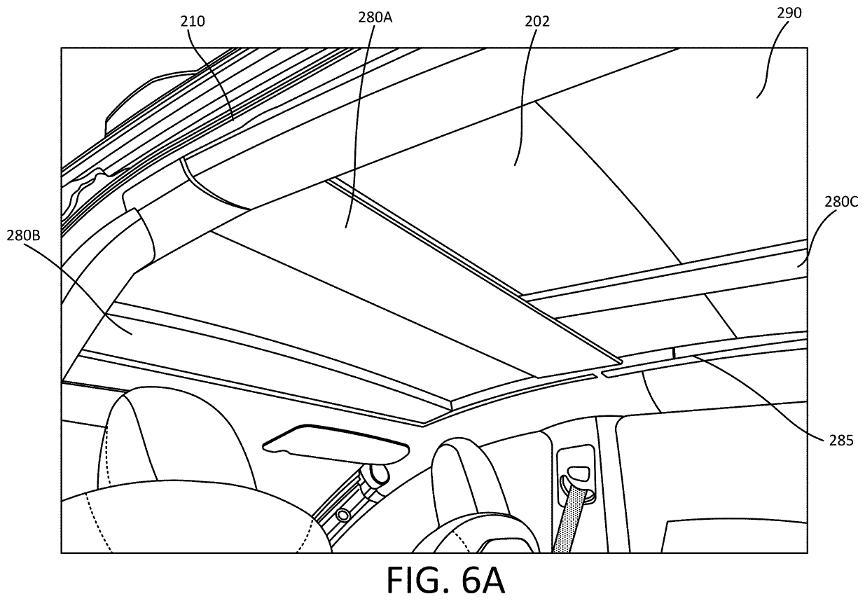

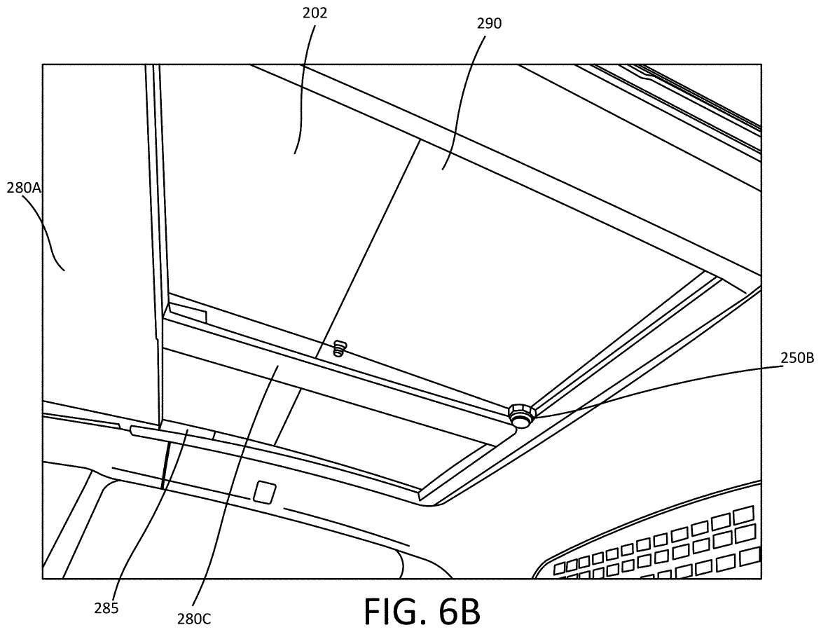

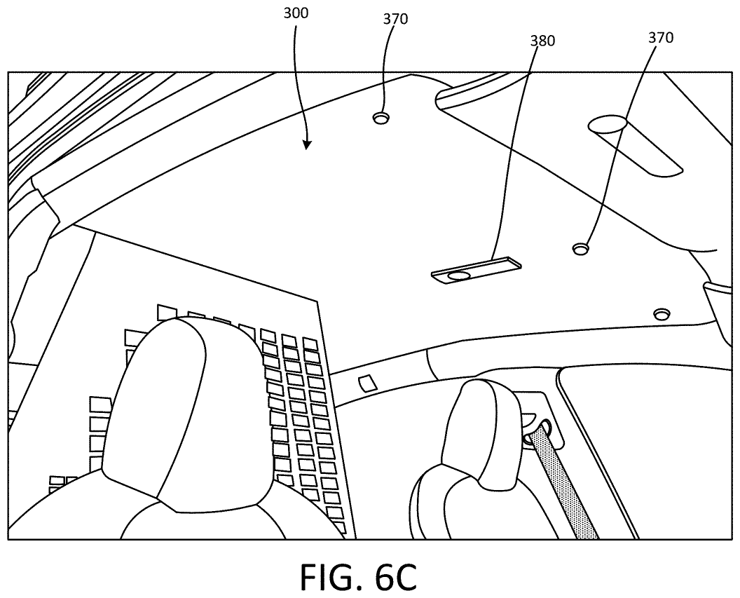

FIG. 5A is a front exterior view, and FIG. 5B is a rear exterior view, of the example roof system 400 shown in FIG. 4, installed in an example vehicle, such as the example vehicle 100 shown in FIGS. 1A-1D, in accordance with implementations described herein. FIGS. 6A and 6B are interior views of the example roof panel 200 shown in FIGS. 1A-2I installed in the example vehicle 100, prior to installation of the example liner panel 300 shown in FIG. 3, in accordance with implementations described herein. FIG. 6C is an interior view of the example roof panel 200, after installation of the example liner panel 300 shown in FIG. 3.

In the example arrangement shown in FIGS. 5A and 5B, an example light bar 510 has been coupled to the roof system 400. In some examples, fasteners may be used to couple the light bar 510 to the roof panel 200 at the first mounting points 250A defined in the roof panel 200. This may allow the light bar 510 to be stably coupled to the vehicle 100 without the use of exterior, after market brackets, connectors and the like. Cabling 515 associated with the light bar 510 may be routed into the space 450 between the roof panel 200 and the liner panel 300, for example via the opening 260 formed in the roof panel 200. In the example arrangement shown in FIG. 5A, an example first camera 521 has been mounted to the roof system 400, at the third mounting point 250C provided at the front portion of the roof panel 200, and an example spotlight 530 has been mounted to the example fourth mounting point 250D provided in the roof panel 200. In the example arrangement shown in FIG. 5B, a second example camera 522 and a third example camera 523 have been mounted at the third mounting points 250C provided at the respective rear portions of the roof panel 200. An example first antenna 541, an example second antenna 542 and an example third antenna 543 have been mounted at the second mounting points 250B provided at the rear portion of the roof panel 200.

The example arrangement of components and/or accessories mounted on the roof panel 200 of the roof system 400 shown in FIGS. 5A and 5B is just one example arrangement and/or combination of components and accessories. More, or fewer components and/or accessories may be coupled to or mounted on the roof system 400, in the same and/or different locations and/or combinations.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A roof system for a vehicle, comprising:
a roof panel defining an exterior facing side of the roof system;
a liner panel defining an interior facing side of the roof system;
a first plurality of mounting points defined in the roof panel and configured to provide for mounting of components to the exterior facing side of the roof system;
a second plurality of mounting points defined in the liner panel and configured to provide for mounting of components to the interior facing side of the roof system; and
a third plurality of mounting points defined in the liner panel and a fourth plurality of mounting points defined in the roof panel, wherein the third plurality of mounting points and the fourth plurality of mounting points are configured to provide for detachable coupling of the liner panel to the roof panel.

2. The roof system of claim 1, wherein the roof panel includes a conductive panel received in a carbon fiber material, wherein the conductive panel defines a ground plane configured to ground at least one component coupled to the roof system via at least one of the first plurality of mounting points or the second plurality of mounting points.

3. The roof system of claim 1, wherein
the roof panel is configured to be coupled to a roof frame portion of a vehicle in which the roof system is installed; and
the liner panel is configured to be detachably coupled to the roof panel coupled to the vehicle.

4. The roof system of claim 3, wherein a peripheral contour of the roof panel corresponds to a peripheral contour of an opening in the vehicle defined by the roof frame portion of the vehicle.

5. The roof system of claim 1, further comprising:
an opening formed in the roof panel; and
a space defined between the roof panel and the liner panel in a coupled configuration of the roof panel and the liner panel, the space being in communication with the opening formed in the roof panel.

6. The roof system of claim 5, wherein
the opening is configured to guide one or more cables from one or more components mounted to the roof panel into the space, and
the space is configured to guide one or more cables from one or more components mounted to at least one of the roof panel or the liner panel to at least one of a power source or an operation panel.

7. The roof system of claim 1, wherein the first plurality of mounting points are configured to provide for mounting to the roof panel of at least one of a light bar, a siren, a speaker, a camera, an antenna, or a spotlight.

8. The roof system of claim 7, wherein the second plurality of mounting points are configured to provide for mounting, to the liner panel, of at least one of a lighting device, a camera, a control panel, or one or more panels configured to provide for separation of an interior cabin of a vehicle in which the roof system is installed.

9. The roof system of claim 1, wherein the roof panel includes:
first side surface defining an exterior surface of the roof system;
a second side surface facing the liner panel in an installed configuration of the roof system in a vehicle; and
a rim arranged in a peripheral portion of the second side surface of the roof panel, extending from the second side surface towards the liner panel in the installed configuration of the roof system.

10. The roof system of claim 9, wherein the roof panel includes a carbon fiber material, the rim is integrally formed with the roof panel.

11. The roof system of claim 9, wherein a peripheral contour of the rim corresponds to a peripheral contour of the roof panel, and wherein the rim is positioned inward from a peripheral portion of the roof panel.

12. The roof system of claim 9, further comprising at least one support panel between the roof panel and the liner panel, wherein the at least one support panel is positioned corresponding to at least one of the first plurality of mounting points or at least one of the second plurality of mounting points, wherein the at least one support panel is configured to provide structural support to one or more components mounted to the roof system via the at least one of the first plurality of mounting points or via the at least one of the second plurality of mounting points.

13. The roof system of claim 12, wherein the at least one support panel includes:
a first support panel positioned between the roof panel and the liner panel, extending across an intermediate portion of the roof system, from a first lateral side portion of the roof panel to a second lateral side portion of the roof panel; and
a second support panel positioned between the roof panel and the liner panel, extending from an intermediate portion of the first support panel to a rear side portion of the roof panel.

14. The roof system of claim 13, wherein the at least one support panel includes a third support panel positioned between the roof panel and the liner panel, extending across a front side portion of the roof panel, the first lateral side portion of the roof panel to the second lateral side portion of the roof panel.

15. The roof system of claim 12, wherein the at least one support panel includes:
a first bent end portion at a first end thereof and configured to be coupled to a corresponding portion of the rim; and
a second bent end portion at a second end thereof and configured to be coupled to a corresponding portion of the rim.

16. The roof system of claim 1, further comprising a plurality of caps configured to be detachably received in the first plurality of mounting points.

17. A method of installing a roof system on a vehicle, the method comprising:
positioning a roof panel on a first side of a roof frame of the vehicle, the roof panel defining a corresponding portion of an exterior surface of the vehicle;
positioning a liner panel on a second side of the roof frame of the vehicle, the liner panel defining a corresponding portion of an interior surface of the vehicle; and
coupling the liner panel and the roof panel to the roof frame, with the roof frame of the vehicle positioned between corresponding peripheral portions of the liner panel and the roof panel.

18. The method of claim 17, wherein coupling the liner panel and the roof panel to the roof frame includes:
coupling the roof panel to the roof frame with a first plurality of fasteners extending through a plurality of mounting points defined in the roof panel and into corresponding brackets provided on the roof frame; and
coupling the liner panel to the roof panel with a second plurality of fasteners extending through a plurality of mounting points defined in the liner panel and into at least one of:
corresponding brackets provided on the roof frame;
corresponding mounting points provided on the roof panel; or
a corresponding support panel coupled to the roof panel.
